(19) United States
(12) Patent Application Publication
(10) Pub. No.: US 2008/0301796 A1
(43) Pub. Date: Dec. 4, 2008

(54) Adjusting the Levels of Anti-Malware Protection

(75) Inventors: Vladimir Holostov, Hadera (IL); Yigal Edery, Pardesia (IL)

Correspondence Address: LEE & HAYES PLLC, 421 W RIVERSIDE AVENUE SUITE 500, SPOKANE, WA, 99201, US

(73) Assignee: MICROSOFT CORPORATION, Redmond, WA (US)

(21) Appl. No.: 11/756,598

(22) Filed: May 31, 2007

(51) Int. Cl. G06F 17/00; G08B 23/00

(52) U.S. Cl. 726/12; 726/24

(57) ABSTRACT

A client transmits requests via a gateway to a server in a network environment. The requests indicate content on a server to be transmitted as part of download process. The gateway receives into its memory the requested content and also maintains characteristics of the server and the client. The gateway adjusts the depth of scanning of the content for malware based on the retrieved server and client characteristics in order to optimize a balance between effectiveness of anti-malware scanning and a resulting user experience.

### BACKGROUND

An anti-malware (AM) application disposed in the network gateway performs an anti-malware scan and inspection of routed traffic between a client computer and a server computer. There are several methods to scan a file for malware (that includes viruses, adware, spware, Trojans or any other undesirable or harmful applications). For example, more than one AM application may scan a given file to search for the most popular signatures (corresponding to one or more malware variants). In particular, the scanning process involves an AM application that detects a malware in the content file being transferred. The AM application performs scanning either by accumulating the whole file before performing the scan or by scanning portions of the content file while other previously scanned portions are being passed to a destination (e.g. client).

In most cases, effectiveness of the scanning process is a measure of performance of the AM application and the user experience at the client. However, there is an inverse correlation between the performance of the application and an associated user experience. Existing malware detection techniques scan files of the same content or file type and disregard characteristics of the content source and destination. This malware detection process results in inefficiencies and a degraded user experience as a significant amount of system resources are used in the scanning process.

### SUMMARY

This Summary introduces concepts in a simplified form that are further described below in the Detailed Description. This Summary is not intended to identify key features or essential features of the claimed subject matter, nor is it intended to be used to limit the scope of the claimed subject matter.

Described herein are, among other things, embodiments of various technologies for use in adjusting the level of anti-malware protection. In accordance with one embodiment, a malware protection application scans content that is transferred from a source electronic device to a destination electronic device. The depth of the malware protection application is dynamically adjusted based on characteristics of the source electronic device and the destination electronic device. By scanning content with the malware protection application having different levels of depth, the efficiency of the scan is increased and the user experience is improved. In addition, all malware verification tools are used while dealing with high-risk content sources.

In another embodiment, a trusted security authority gathers threat information relating to a network malware threat level from one or more computing devices. The security authority verifies the threat information and distributes the verified threat information to other computing devices.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is an exemplary architecture of a malware detection system for adjusting the level of anti-malware protection.

FIG. 2 is a block diagram depicting selected modules of a collection server in an anti-malware scanning system for gathering threat information.

FIG. 3 is a chart depicting a scanning depth of a malware scan operation using different scanning modes.

FIG. 4 is a flow diagram of an exemplary process used for adjusting the level of anti-malware protection in a network gateway.

FIG. 5 is a flow diagram depicting an exemplary process for detecting and distributing malware threat information to a many computing devices.

### DETAILED DESCRIPTION

### Overview

Described herein are, among other things, embodiments of various technologies for adjusting the level of anti-malware (AM) protection. In accordance with one embodiment, an AM scanning system dynamically adjusts the depth of the malware scan operation by the AM protection application. The adjustment is made based on characteristics of a source electronic device, a destination electronic device, requesting device, characteristics of transmitted content, and a threat level established by a response center to improve system efficiencies.

### Example System Architecture

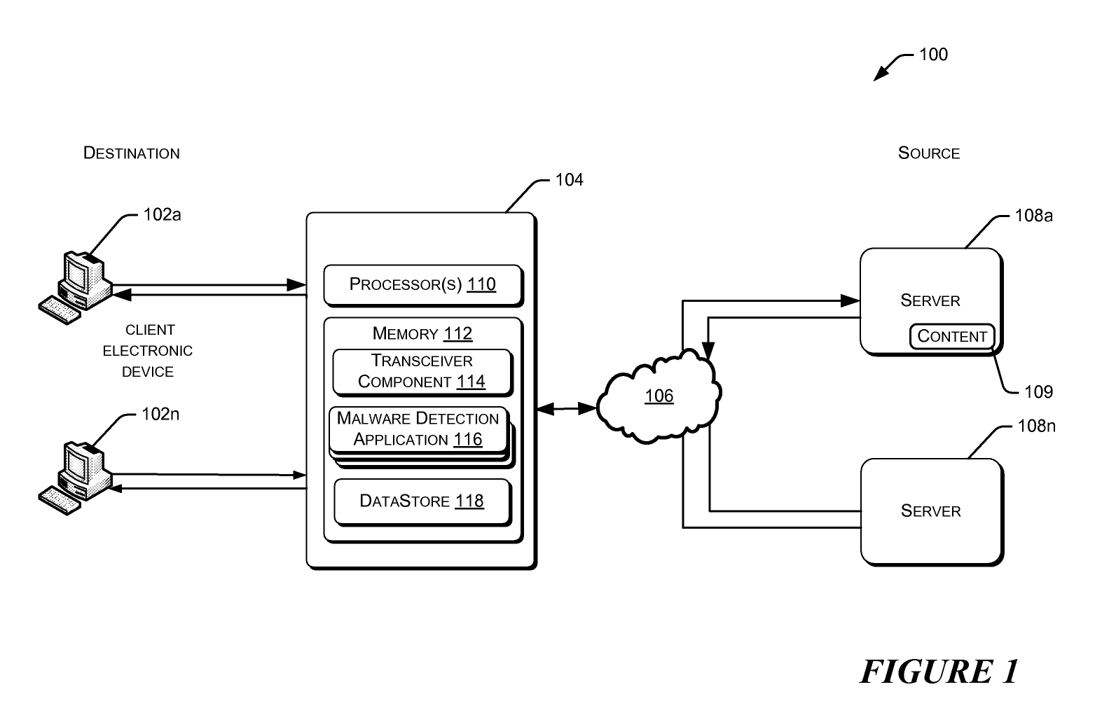

Illustrated in FIG. 1 is a malware detection system 100 including clients (also referred to as “destination electronic devices” or “client electronic devices) 102a-102n connected via network gateway 104 and a network 106 to remote servers (also referred to herein as source electronic devices) 108a-108n. Although network gateway 104 is shown, any type of network processing device that can scan for malware may be substituted for gateway 104. Examples of such a processing device include a proxy server and a general purpose computer.

Stored in server 108a is a file containing content 109 to which client 102a requests access. Although client 102a will be discussed herein, client electronic device 102n operates synonymously with client electronic device 102a. Content 109 includes, but is not limited to, applications, data, media data, archival information, web pages, and scripting information.

In one embodiment, server 108a arranges content 109 in the form of portions. Client 102a transmits a request indicating that the portions of content 109 be transferred (e.g. downloaded) in a sequential order. Such requests are received by gateway 104, which then feeds the request via network 106 to server 108a. Server 108a responds by transmitting content 109 via network 106 to gateway 104.

Gateway 104 includes one or more processors 110 and memory 112. Memory 112 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

In an exemplary embodiment, gateway 104 includes a transceiver component 114 that receives content 109 from server 108a and passes the received content to malware detection application 116 for scanning. Transceiver component 114 also transmits the scanned content from malware detection application 116 to clients 102(a-n). Transceiver component 114 further receives information and requests from clients 102(a-n) and feeds those requests to servers 108(a-n). In one embodiment, such requests may conform to a hyper-text transfer protocol (HTTP) and a transmission control protocol/internet protocol (TCP/IP).

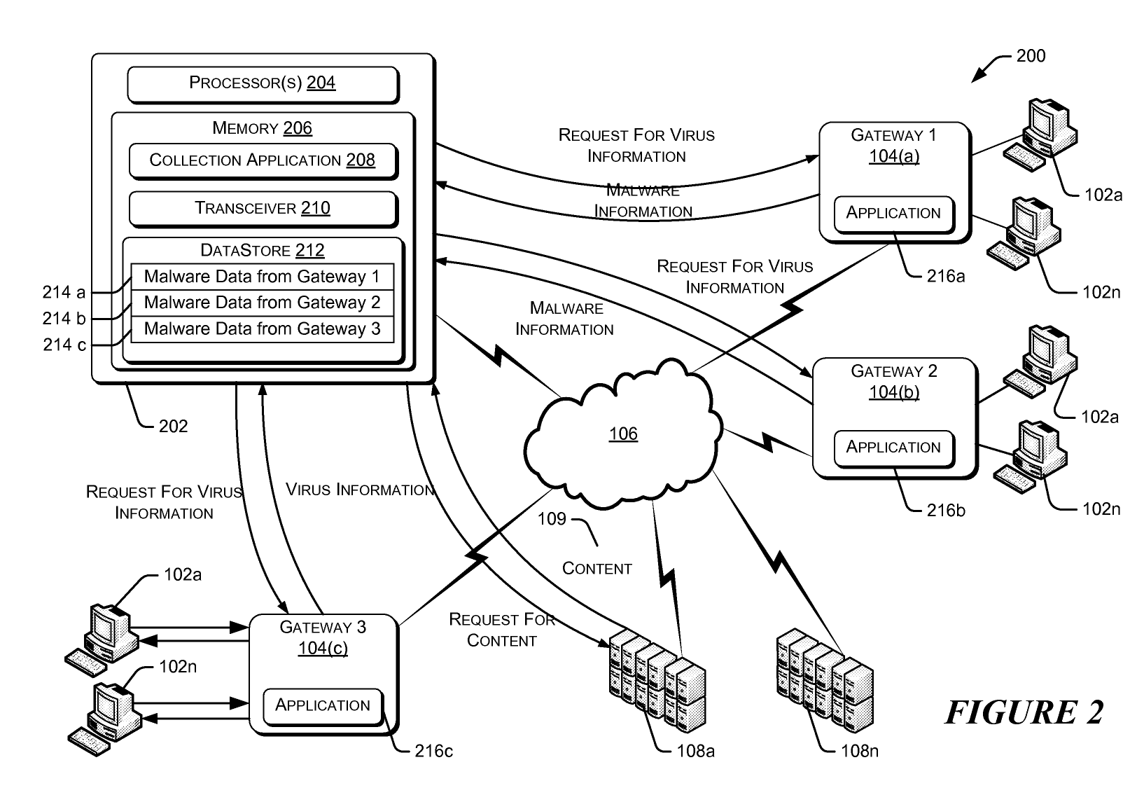

Transceiver component 114 also transmits requests to server 108a and client 102a for source and destination characteristics respectively. Statistics regarding server 108a and client 102a are maintained by gateway 104 based on statistics and information obtained from a collection server 202 (FIG. 2). These characteristics may include, for example, the content type, the security zone, the infection history, the threat level, and the minimal protection level (current protection level set by administrator). Transceiver component 114 receives such characteristics and stores them in a datastore 118.

One or more malware detection applications 116 (also referred to as an “AM engine”) are disposed in gateway 104 and scan the received content for the presence of one or more malware variants. In an exemplary implementation, malware detection application 116 adjusts the depth of scanning the content based on the source and destination characteristics. Adjusting the depth of the malware scan operation includes adjusting the anti-malware engine bias (performance/certainty), adjusting an amount of information (content) to be passed to client 102a while the content is being scanned and adjusting the number of malware detection applications (engines) 116. Virus detection application 116 may also set a maximum or minimum level of depth of the malware scan operation.

In a scan operation, malware detection application 116 scans information included in content 109 to determine a malware. The malware types may be stored in datastore 118 included in gateway 104 or may be incorporated in the malware detection application 116. A match found for the malware during the scan operation confirms the presence of a malware. The malware datastore 118 or application 116 is periodically updated with new malware signatures. When content 109 is received in the portions, gateway 104 assembles the portions and scanning is performed by comparing portions of the assembled file against the malware reference signature.

In one embodiment if a malware is detected in content 109, malware detection application 116 prevents transfer of content 109 to client 102a. Alternatively, malware detection application 116 purges an infected portion of content 109 and prevents transfer of such portions to client 102a. Also upon malware detection, an indication may be provided to client 102a that specifies the portion of the content 109 that is infected. Such indication may be provided, for example, by embedding a malware indication with the infected portions sent to the client 102a or by sending the indication to a system administrator (not shown). Subsequent to detection of a malware, the malware detection application 116 updates datastore 118 to include information about the detected malware. Such information may include, for example, the time and date of detection, the number of times the malware has been detected, and the particular uniform resource locator (URL) corresponding to the source of malware. Client characteristics (e.g. the requesting client device) are stored for statistical purposes and used to determine the optimal protection level.

If malware detection application 116 does not detect a malware, gateway 104 makes received content available to client 102a. In the case when content 109 was received in portions, gateway 104 disassembles the content 109 (after scanning) into portions that are then arranged in a sequential order of the request from client 102a. Gateway 104 then transfers the content in small portions to the client 102a before the whole file is accumulated and scanned to improve user experience. This is because a user of the client 102a does not have to wait for a long time period to obtain control, and the scanned portions of the content are transferred while the remaining portions are being received and scanned. On the other hand, scanning completely downloaded content provides a higher degree of security as compared to scanning portions of the content because a malware may be spread over multiple portions of the content.

Stored in datastore 118 may be data that includes the names or the network addresses (such as a URL) for the content 109 from one of servers 108(a-n) in which malware was previously detected. In one implementation, malware detection application 116 utilizes such data to adjust the depth of malware protection (e.g. the scanning operation).

### Collection Server:

In FIG. 2, there is shown a simplified block diagram of a system 200 illustrating a malware collection and reporting system, which includes multiple gateways 104 (a-c). System 200 is presented for collecting malware information from subscriber applications 216(a-c) in gateways 104 (a-c) respectively. To this end, the system 200 includes a collection server 202 configured to gather malware information, including malware threat information, from multiple remote gateways 104 (a-c) that are in communication with the collection server 202 via the network 106. The subscriber applications 216(a-c) subscribe to a collection and reporting service in the collection server 202.

The collection server 202 stores and executes computer-executable instructions that provide the collection and reporting service. In one example, collection server 202 includes one or more processors 204 and a memory 206. Memory 206 may include volatile memory, nonvolatile memory, removable media and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

In one embodiment, memory 206 includes a collection application 208, a transceiver 210, and a datastore 212. These modules and applications may be implemented in hardware or as computer-executable instructions that are executed by one or more processors 204.

Collection application 208 enables collection of information pertaining to malware from gateways 104 (a-c) to implement unified threat management system. As shown in FIG. 2, gateways 104 (a-c) (also referred to as “Subscribers”) communicate with collection server 202. Servers 108 (a-n) host website content and supply the content to clients 102(a-n) via network 106 and gateways 104(a-c).

In operation, the collection application 208 periodically receives malware threat information from each of subscriber gateways 104 (a-c) with transceiver 210. Virus threat information may include a URL and domain names of high-risk sources (e.g. the domain name of servers 108(a-n)). On receipt of such a request, the subscriber applications 216(a-c) in each of the gateways 104(a-c) sends the malware threat information maintained in its respective datastore 118 to server 202. Collection application 208 receives the malware information from Gateways 104(a-c) (Illustrated as Gateways 1-3 in FIG. 2) and stores the malware threat information as records 214 (a-c) in datastore 212.

Such malware threat information includes both URLs corresponding to the infected domains and the overall threat level for various subscriber gateways 104 (a-c). The malware threat information is associated with content 109 in a particular website within servers 108 (a-n) and indicates the presence of malware within the content.

If the malware threat information indicates that a malware is present, collection application 208 sends, using transceiver 210, a request to retrieve corresponding content from the allegedly infected website hosted on one of servers 108(a-n). Collection application 208 receives the retrieved content and compares the content with the malware reference signature stored in datastore 212. If the content matches the signature, collection application 208 updates the datastore 212 to include the data (e.g. URL and domain name) associated with the detected malware in a list of high risk sources. Collection server 202 enables gateways 104(a-c) to access the list.

Subsequent to detection of the malware, the threat information, is distributed by anti-malware vendors and received by subscriber gateways 104 (a-c). Such threat information indicates the recently discovered vulnerabilities (malware) (e.g. that a malware was detected). Collection application 208 makes the threat information available for subscriber gateways 104 (a-c) through transceiver 210. In yet another implementation, when there is a widespread malware threat that affects a particular application or content type, collection application 208 may raise the threat level for that content type by providing a threat level indication information to gateways 104 (a-c). Upon receipt of the information, malware detection application 116 adjusts the depth of the scan operation based on the content type being received from one of the servers 108(a-n) and the threat level indication. A high threat level indication result in a high-level of anti-malware protection by malware detection application 116. For example, as a result of the high threat level, malware detection application 116 more thoroughly scans the received content until notification is received of a reduced threat.

### Scanning Depth:

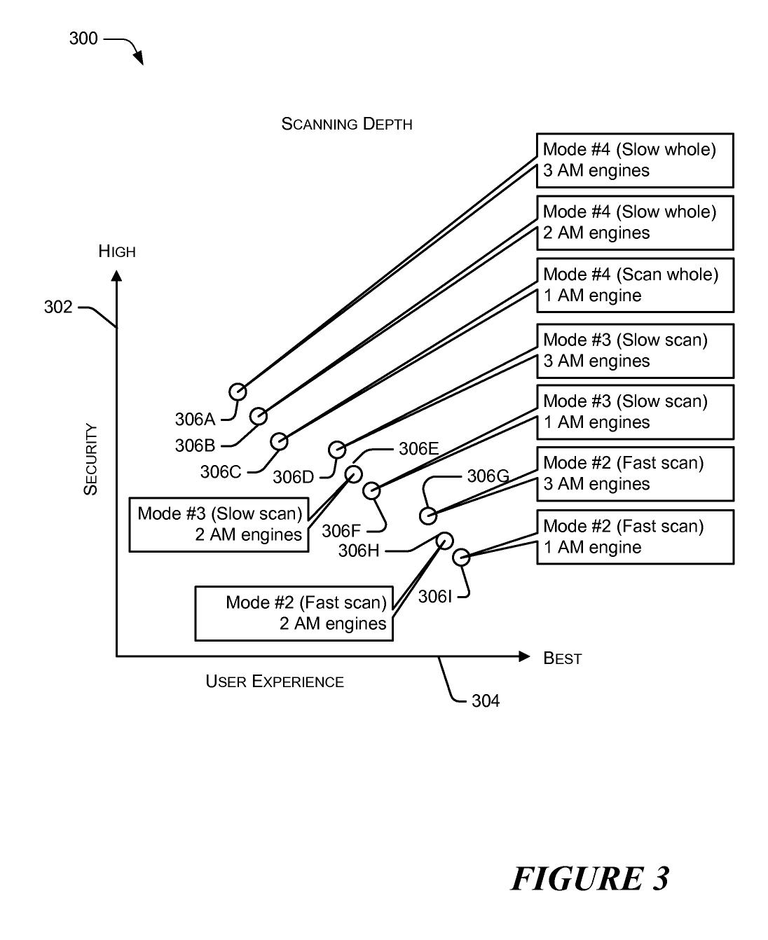

FIG. 3 illustrates a graphical representation 300 of different levels of scanning depth of malware detection application 116. As shown, axis 302 corresponds to the security level of malware detection application 116 and axis 304 corresponds to user experience at one of clients 102(a-n). The circles (e.g. application modes 306(A-I)) depicts methods for scanning content 109. The graphical representation 300 also presents different levels of security and user experiences corresponding to each of the methods of scanning adopted by malware detection application 116.

Table 1 shown below illustrates an exemplary list of different modes of scanning performed by malware detection application 116 and used in adjusting the scanning efficiency. Other techniques may also be used in adjusting the scanning efficiency. For example, certain inspection methods including heuristics, sandbox execution can be used.

TABLE 1

| Mode | Scan Mode |
|---|---|
| 1 | Do not scan |
| 2 | Fast scan - pass all scanned portions to the client |
| 3 | Slow scan - pass minimal amount of data to the client while the |
| | file is being scanned. |
| 4 | Accumulate the whole file, scan before passing the content |
| 5 | Block the file completely |

As illustrated in Table 1, malware detection application 116 may run in one of the five scan modes, namely scan modes 1-5, that change the depth of the scan and the scan level. Additional parameters may be defined for each of the scan modes (1-5), namely: the number of anti-malware engines, the edition of the malware reference signature dictionary, and the ability to partially scan content 109. Each of these additional parameters may be selected independently by collection application 208 to define one of the application modes 306 (A-I) shown in FIG. 3.

For example, application mode 306A corresponds to scan mode 4 with a slow scan of the file and uses three anti-malware engines. Application mode 306A may also employ a full malware signature dictionary and partially scan the content 109. In addition in application mode 306A, the entire file of content 109 may be accumulated and scanned for malware before the content is passed to one of the clients 102 (a-n).

By way of another example, application mode 306F corresponds to slow scan mode 3 in Table 1. Scan mode 3 employs one anti-malware engine with a full version of the malware signature dictionary enabled. As defined in Table 1, scan mode 3 passes the minimal amount of data to client 102a while content 109 is being scanned. Also, application mode 306A provides a better malware protection as compared to application mode 306F. Similarly, other application modes shown in FIG. 3 may also be implemented by selecting a respective number of anti-malware engines with either a basic or full edition of a signature dictionary and with partial or full scanning of content 109. It may be appreciated that each of the modes corresponds to different levels of anti-malware protection, also referred to herein as a different “depth of the scanning operation.”

In an exemplary configuration, malware detection application 116 can select one of scan modes 1-5, as part of the use of the modes illustrated in FIG. 3. The scan mode is selected depending upon characteristics of the source server 108(a-n) and/or the destination client 102(a-n).

Table 2 illustrates an exemplary list of server and client characteristics and a corresponding description for those characteristics.

TABLE 2

| Characteristic | Description |
|---|---|
| Content type | Applications, Image, Data, Media, Archives, Audio, |
| | Office, HTML, Scripts etc. |
| Security zone | Trusted, General, High-Risk, Restricted |
| Infections history | Number of infections detected when serving requests |
| | of a particular client device or user |
| Threat level | Alerts regarding specific malware exploiting |
| | recently discovered vulnerabilities |
| Minimal | Configured by system administrator |
| protection level | |

As depicted in Table 2, the characteristics include, but are not limited to, the content type, the security zone, the infection history, the threat level, and the minimal protection level. Virus detection application 116 adjusts the scan level of the anti-malware protection application based on these factors. The level of adjustment may be stored in a table in datastore 118 by a system administrator and may be periodically updated. For example, a particular content type may be susceptible to malware attack based on the past history of the content. Virus detection application 116 implements a high protection scan level when such content is transferred between client 102a and server 108a. Alternatively, if a content type (e.g. a media file) contains trusted content and is known to be less prone to malware attack, malware detection application 116 implements a low level of protection.

Virus detection application 116 can also adjust the depth of malware protection based on the security zones of server 108a. For example, a higher protection scan level is implemented for a high-risk security zone as compared to a trusted or a general security zone.

In another implementation, gateway 104 keeps a record of the number of infections detected when serving request of a particular client (e.g. client 102a). In such an implementation, malware detection application 116 adjusts the depth of malware protection based on the infection history of clients 102(a-n). For example, malware detection application 116 implements a high protection scan level for a client that has a bad infection history. Alternatively, malware detection application 116 implements a low protection scan level for a client with a good infection history.

In one of the configurations, malware detection application 116 adjusts the depth of anti-malware protection based on a threat level as notified by collection server 202. For example, if collection server 202 alerts malware detection application 116 as to the presence of many malware attacks, a high scan level of protection is implemented.

In yet another embodiment, a system administrator configures a minimal scan level of anti-malware protection. Correspondingly, malware detection application 116 ensures that the scan level does not fall below the minimum level.

The depth of the malware detection application 116 may also be configured by an administrator to a minimum and maximum scan level based on the type of content being scanned.

For example, if an audio file or audio content is being scanned, a minimum scan level may be set having scan mode 2 with one anti-malware engine, a basic edition of the malware dictionary and partial scanning enabled. On the other hand, the maximum scan level may be set having scan mode 3 with three anti-malware engines, a full edition of the malware dictionary and partial scan disabled.

### Exemplary Process

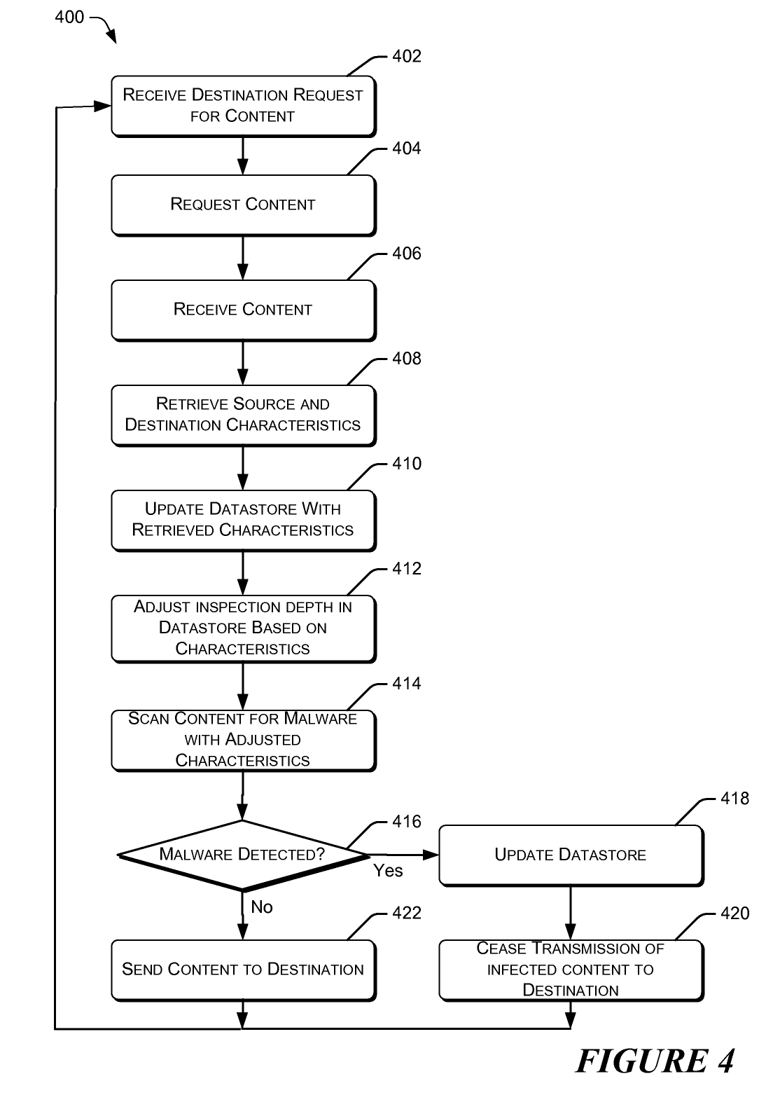

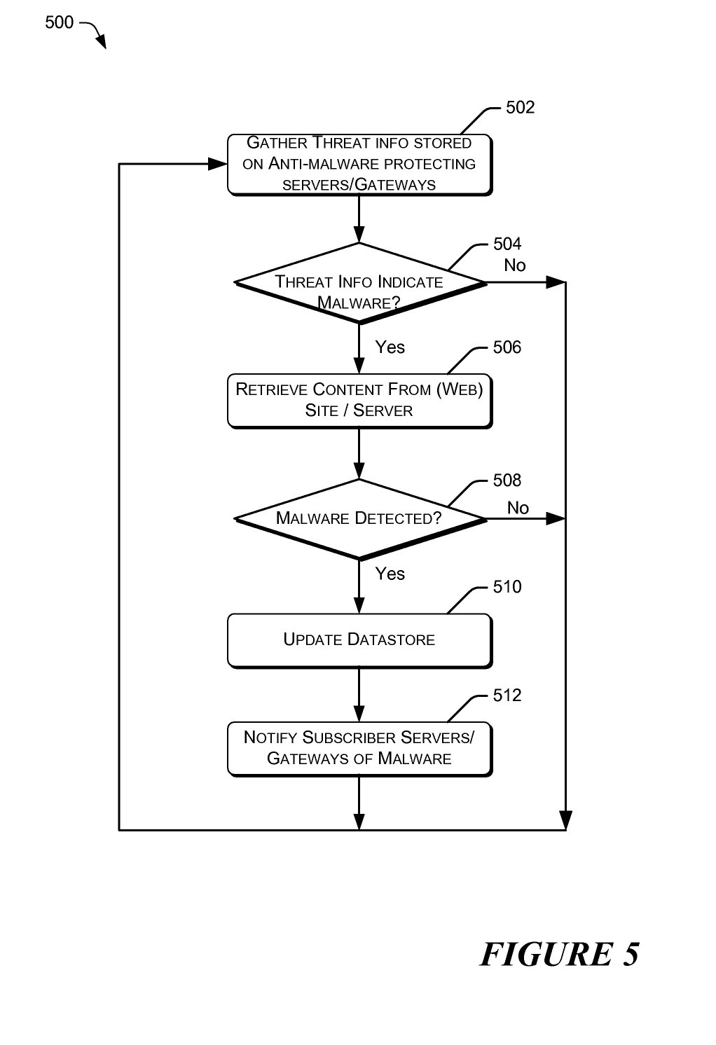

The exemplary process in FIG. 4 and FIG. 5 are illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to system 100 of FIG. 1 and system 200 of FIG. 2, although the process may be implemented in other system architectures.

FIG. 4 illustrates a flow diagram of an exemplary process 400 used by exemplary gateway 104 (see FIG. 1) of the malware detection system 100, to scan available content 109 for malware. Although the flow diagram is depicted in the order of blocks shown, blocks 402-422 do not have to be implemented in any particular order.

At block 402, gateway 104 receives requests from destination electronic device (e.g. client 102a) for content 109 stored in a source electronic device (e.g. server 108a).

At block 404, gateway 104 requests that server 108a transfer content 109. Server 108a, upon receipt of such a request, sends content 109 to gateway 104.

At block 404, gateway 104 receives content 109 from server 108a using transceiver component 114 and stores the content in datastore 118.

At block 408, gateway 104 maintains the source and the destination characteristics of the server 108a and client 102a, respectively, for content 109 stored in a file. Such characteristics may include, for example, the content type, the content's security zone, the infection history of previously received related content, the threat level, and the present protection level set by the administrator. For example, the gateway 104 determines the security zone of the server 108 and maintain client's 102 history

At block 410, gateway 104 updates datastore 118 with the server and clients characteristics retrieved at block 408.

At block 412, gateway 104 adjusts the depth of malware protection based on the received characteristics stored in datastore 118. To substantiate, malware detection application 116 adjusts the scan level of anti-malware protection based on the server and clients characteristics. The adjusted scan level of the anti-malware protection is stored in datastore 118. Alternatively, adjusting the depth includes one or more of: adjusting the size and the number of received portions of content 109 that is scanned for malware, adjusting an amount of information (in content 109) to be passed to client 102a while the content 109 is being scanned, and adjusting the number of malware detection applications 116 that scan content. Adjusting the depth of malware protection may also include setting a minimum and maximum level of the scan mode.

At block 414, malware detection application 116 in the gateway 104 scans content 109 with the adjusted depth of the malware protection.

At block 416, malware detection application 116 determines the presence of a malware in content 109 as a result of the scan operation performed at block 414. In one embodiment, scanning is performed by comparing the content information with the malware reference signature stored in datastore 118. If the comparison finds a match (“yes” to block 416), the presence of a malware in content 109 is confirmed. Upon detection of a malware, the process moves to block 418. If a malware is not detected (“no” to block 416), the process moves to block 422.

In block 418, the gateway 104 updates datastore 118 to record information about the detected malware. Such information may include, for example, the time and date of detection, the number of times the malware has been detected, the particular URL which characterizes the source of the malware and the nature of the malware.

At block 420, gateway 104 purges the malware and ceases transmission of infected content to client 102a. Alternatively, gateway 104 provides an indication of the detected malware to an administrator device (not shown) or to the client 102a in block 420.

If a malware was not detected (“no” to block 416), gateway 104 feeds content 109 to client 102a at block 422.

FIG. 5 illustrates a flow diagram of an exemplary process 500 used by collection server 202 (see FIG. 2) of the malware detection system 200 to provide malware threat information to the gateways 104 (a-c). Although the flow diagram is depicted in the order of blocks shown, blocks 502-512 do not have to be implemented in any particular order.

At block 502, collection server 202 gathers threat information from the subscriber gateway 104 hosting malware protection application 116. In operation, collection server 202 periodically receives indications that threat information is available from each of the subscriber gateways 104 (a-n). Threat information may include the URL or the domain name of high-risk sources (e.g. server 108a). Subsequent to receipt of the indication, subscriber gateways 104 (a-n) send threat information, stored in their respective datastore 118, using transceiver 210 to collection server 202. Collection server 202 receives the threat information and stores it in datastore 212.

At block 504, collection server 202 using collection application 208 verifies whether threat information gathered at block 502 indicates a malware was detected. In one embodiment, the collection server 202 may be a trusted authority. Particularly, collection server 202 receives request for verification of infected domains, uniform resource locators (URLs), and overall threat type and content type detected by various subscriber gateways 104 (a-n). Subscriber gateway 104 notifies collection server 202 about malware threat information associated with content 109 received from a particular web site/server 108 (a-n). Collection server 202 verifies whether the threat information indicates a presence of malware or not. If the threat information indicates a malware presence, the process moves to block 506 (“yes” to block 504). If threat information does not indicate a malware presence (“no” to block 504), the process continues in block 502.

At block 506, collection server 202 retrieves content 109, identified by the threat information, from a web site hosted by one of servers 108(a-n). The web site may be identified by the URL and/or the domain name indicated in the threat information.

At block 508, collection server 202 using collection application 208 verifies that a malware is present in the retrieved content. In one implementation, collection server 202 using collection application 208 receives the retrieved content and fully scans the information contained therein using a malware reference signature stored in datastore 212. If the comparison finds a malware (“yes” to block 508), the process moves to update the datastore 212 in block 510. If the comparison does not find a malware, the process gathers threat information in block 502.

At block 510, collection server 202 updates the datastore 212 to include data (e.g. URL and domain name) associated with the detected malware.

At block 512, one or more subscriber gateways 104(a-c) request the presence of the detected malware from collection server 202. In addition, collection server 202 distributes threat information (information about detected malware) to subscriber gateways 104 with monitored vulnerabilities (malware). In yet another implementation, when there is a detected widespread malware threat that affects a particular application or content type, system 200 may raise the threat level and scanning mode for that content type. In a successive progression, malware detection application 116 adjusts the depth of scan operations based on the content type or the threat level.

### CONCLUSION

In closing, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising dynamically adjusting a depth of a malware protection application that scans content transferred to a destination electronic device from a source electronic device based on characteristics of the source and destination electronic devices.

2. The method as recited in claim 1, wherein the malware protection application scans the content to determine if the content matches a malware signature.

3. The method as recited in claim 1, wherein adjusting the depth comprises adjusting a portion of the content that is scanned, adjusting an amount of the content passed to the destination electronic device while the content is being scanned, adjusting a number of malware detection engines that scan the content, using predetermined number of signature sets, or executing various scanning methods that include heuristics or sandbox execution.

4. The method as recited in claim 1 wherein the depth has a level and wherein the method further comprises setting a minimum level and maximum level of the depth.

5. The method as recited in claim 1, wherein the destination electronic device is disposed at a destination location and the source electronic device is disposed at a source location remote from the destination location.

6. The method as recited in claim 1, wherein the characteristics comprise a content type, a security zone, an infection history, a threat level, or a preset protection level.

7. The method as recited in claim 6, wherein the security zone includes a trusted zone, a general zone, a high-risk zone or a restricted information zone.

8. A method comprising adjusting a depth of a malware protection application that scans content transferred to a client electronic device based on a history of infections associated with the client electronic device.

9. The method as recited in claim 8, wherein the malware protection application scans the content to determine if the content matches a malware reference signature.

10. The method as recited in claim 8, wherein the content is formatted into portions, and wherein adjusting the depth comprises:
adjusting which portion of the content is scanned, adjusting an amount of information transferred to the client electronic device while the content is being scanned or adjusting a number of malware detection engines that scan the content.

11. The method as recited in claim 10, further comprising setting a minimum and maximum level of the depth.

12. The method as recited in claim 8, wherein the content comprises:
applications, data, media data, archival information, Web pages or scripting information.

13. The method as recited in claim 8, wherein a server transfers content to the client electronic device via a gateway, wherein the malware protection application is executed on the gateway, and wherein the history of infections includes a number of infections detected by the gateway in content transferred to the client electronic device for use by a particular user, and wherein the method further comprises increasing the depth for the malware protection application associated with the particular user of the electronic device when content is transferred to the client electronic device for use by the particular user.

14. A method comprising:
gathering, from a plurality of computing devices, threat information with a trusted security authority relating to a network malware threat level;
verifying the threat information; and
distributing the verified threat information to the plurality of computing devices.

15. The method as recited in claim 14, wherein the threat information is gathered from servers tracking malware occurrences.

16. The method as recited in claim 14, wherein the threat information includes a uniform resource locator (URL) and a domain name of a high-risk source.

17. The method as recited in claim 14, wherein verifying the threat information includes accessing a suspected high-risk source and obtaining infected content from the source.

18. The method as recited in claim 14, further comprising adjusting a depth of a malware protection application of the plurality of computing devices based on the distributed verified threat information.

19. The method as recited in claim 14, wherein a malware protection application at the plurality of computing devices scans content to detect a malware signature.

20. The method as recited in claim 19 further comprising determining file types affected by the threat information, and changing depth of the malware protection application only for the affected file types.
